(19) United States
(12) Patent Application Publication
(10) Pub. No.: US 2021/0284572 A1
(43) Pub. Date: Sep. 16, 2021

(54) LOW TEMPERATURE LASER BLEACHING OF POLYCHROMATIC GLASS CERAMICS

(71) Applicant: Corning Incorporated, Corning, NY (US)

(72) Inventors: Matthew John Dejneka, Corning, NY (US); Jesse Kohl, Horseheads, NY (US); Alexander Mikhailovich Streltsov, Corning, NY (US)

(21) Appl. No.: 17/183,539

(22) Filed: Feb. 24, 2021

Related U.S. Application Data
(60) Provisional application No. 62/989,280, filed on Mar. 13, 2020.

(51) Int. Cl. C03C 23/00; C03C 4/00; C03C 10/00

(52) U.S. Cl. CPC C03C 23/0025; C03C 4/0071; C03C 2204/00; C03C 10/0054; C03C 10/0027

(57) ABSTRACT

A method of marking a glass-ceramic article includes the steps of: illuminating a glass-ceramic article with a beam from a laser, the glass-ceramic article having a thickness, T; and forming a mark in the glass-ceramic article while translating at least one of the glass-ceramic article or laser. The mark has a Contrast Ratio greater than 10. The step of forming a mark includes focusing the beam from the laser within the thickness, T, of the glass-ceramic article. The focusing of the beam results in alteration of a chemical property or a physical property of the glass-ceramic article. The mark produced by the beam from the laser extends through at least 50% of the thickness, T, of the glass-ceramic article. The glass-ceramic article may have a global temperature less than 100° C. during the marking process and does not fracture as the mark is formed.

This application claims priority under 35 USC § 119(e) from U.S. Provisional Patent Application Ser. No. 62/989,280, filed on Mar. 13, 2020, and which is incorporated by reference herein in its entirety.

### BACKGROUND

The present invention generally relates to glass ceramics. More specifically, the present disclosure relates to laser bleaching of glass ceramics.

### SUMMARY

According to one aspect of the present disclosure, a method of marking a glass-ceramic article includes the steps of: illuminating a glass-ceramic article with a beam from a laser, the glass-ceramic article having a thickness, T; and forming a mark in the glass-ceramic article while translating at least one of the glass-ceramic article or laser. The mark may have a Contrast Ratio greater than 10. The step of forming a mark includes focusing the beam from the laser within the thickness, T, of the glass-ceramic article. The focusing of the beam results in alteration of a chemical and/or physical property of the glass-ceramic article. The glass-ceramic article may have a global temperature less than 100° C. during the marking process and does not fracture as the mark is formed.

In some examples of the first aspect, a global temperature of the glass-ceramic article during the method of marking a glass-ceramic article is less than 100° C. In various examples, an interaction between the beam from the laser and the glass-ceramic article provides the sole source of heating in the method of marking a glass-ceramic article. The steps of illuminating the glass-ceramic article with a beam from a laser and focusing the beam from the laser within the thickness, T, of the glass-ceramic article may induce the alteration of the at least one of a physical property and a chemical property of the glass-ceramic article as a result of local exposure of the glass-ceramic article to the beam from the laser. In some examples, the local exposure of the glass-ceramic article to the beam from the laser may locally heat the glass-ceramic article to a temperature that is above a glass transition temperature, T_{g}, of the glass-ceramic article. In various examples, the local exposure of the glass-ceramic article to the beam from the laser may locally heat the glass-ceramic article to a temperature that is below a softening point of the glass-ceramic article. In some examples, the local exposure of the glass-ceramic article to the beam from the laser may locally heat the glass-ceramic article to a temperature that is above a softening point of the glass-ceramic article. The local exposure of the glass-ceramic article to the beam from the laser may heat a region of the glass-ceramic article that interacts with the beam from the laser to a temperature of less than 1000° C., less than 800° C., or less than 600° C. in some examples. In various examples, the step of altering at least one of a physical property and a chemical property of the glass-ceramic article with the beam from the laser includes changing an oxidation state of an ion of the glass-ceramic article with which the beam from the laser has interacted.

In various examples of the first aspect, the marking produced in the glass-ceramic article by the laser extends through at least 50%, at least 80%, or through an entirety of the thickness, T, of the glass-ceramic article.

In examples of the first aspect, the marking produced in the glass-ceramic article by the laser has a resolution in the range of 10-20 μm.

In some examples of the first aspect, the marking produced in the glass-ceramic article by the laser has an average internal optical transmittance in the marked region that is at least 2 times the average internal optical transmittance over at least a 50 nm wide wavelength window in an unbleached (unmarked) region of the glass-ceramic article.

In various examples, the laser utilized in the method of marking a glass-ceramic article may have an operating wavelength that aligns with a local maximum in a transmittance spectrum of the glass-ceramic article, with the local maximum having a transmittance that is in the range of greater than 20% and less than 80% for a wavelength within the range of 2500 nm to 2800 nm. In some examples, the laser utilized in the method of marking a glass-ceramic article may have an operating wavelength that aligns with a local maximum in a transmittance spectrum of the glass-ceramic article, with the local maximum having a transmittance that is in the range of greater than 25% and less than 60% for a wavelength within the range of 2500 nm to 2800 nm. In examples, the laser utilized in the method of marking a glass-ceramic article may have an operating wavelength that aligns with a local maximum in a transmittance spectrum of the glass-ceramic article, with the local maximum having a transmittance that is in the range of greater than 30% and less than 40% for a wavelength within the range of 2500 nm to 2800 nm. In various examples, the local maximum in the transmittance spectrum of the glass-ceramic article may represent an O—H phonon fundamental absorption band.

Additional features and advantages will be set forth in the detailed description which follows, and in part will be readily apparent to those skilled in the art from that description or recognized by practicing the embodiments as described herein, including the detailed description which follows, the claims, as well as the appended drawings.

It is to be understood that both the foregoing general description and the following detailed description are merely exemplary, and are intended to provide an overview or framework to understanding the nature and character of the claims. The accompanying drawings are included to provide a further understanding, and are incorporated in and constitute a part of this specification. The drawings illustrate one or more embodiments, and together with the description serve to explain principles and operation of the various embodiments.

### BRIEF DESCRIPTION OF THE DRAWINGS

FIG. 1 is a front perspective view of an article, illustrating various dimensions, according to one example;

FIG. 2 is a flow diagram illustrating a method of marking the article, according to one example;

FIG. 3 is a front perspective view of the article, illustrating a marking, according to one example;

FIG. 4 is a transmittance versus wavelength plot of Article 1 and Article 2;

FIG. 5 is a power versus wavelength tuning curve for a laser of the present disclosure;

FIG. 6A is a top perspective view of a glass-ceramic article that has been marked, illustrating reflected light, according to one example;

FIG. 6B is a top perspective view of the glass-ceramic article that has been marked, illustrating transmitted light, according to one example; and

FIG. 7 depicts a series of exemplary Raman spectra for an article that was manufactured and not heat-treated, a region of a heat-treated article that was not marked, and a region of a heat-treated article that was marked.

### DETAILED DESCRIPTION

Reference will now be made in detail to the present preferred embodiments, examples of which are illustrated in the accompanying drawings. Whenever possible, the same reference numerals will be used throughout the drawings to refer to the same or like parts.

Additional features and advantages of the invention will be set forth in the detailed description which follows and will be apparent to those skilled in the art from the description, or recognized by practicing the invention as described in the following description, together with the claims and appended drawings.

As used herein, the term “and/or,” when used in a list of two or more items, means that any one of the listed items can be employed by itself, or any combination of two or more of the listed items can be employed. For example, if a composition is described as containing components A, B, and/or C, the composition can contain A alone; B alone; C alone; A and B in combination; A and C in combination; B and C in combination; or A, B, and C in combination.

In this document, relational terms, such as first and second, top and bottom, and the like, are used solely to distinguish one entity or action from another entity or action, without necessarily requiring or implying any actual such relationship or order between such entities or actions.

Modifications of the disclosure will occur to those skilled in the art and to those who make or use the disclosure. Therefore, it is understood that the embodiments shown in the drawings and described above are merely for illustrative purposes and not intended to limit the scope of the disclosure, which is defined by the following claims, as interpreted according to the principles of patent law, including the doctrine of equivalents.

It will be understood by one having ordinary skill in the art that construction of the described disclosure, and other components, is not limited to any specific material. Other exemplary embodiments of the disclosure disclosed herein may be formed from a wide variety of materials, unless described otherwise herein.

For purposes of this disclosure, the term “coupled” (in all of its forms: couple, coupling, coupled, etc.) generally means the joining of two components (electrical or mechanical) directly or indirectly to one another. Such joining may be stationary in nature or movable in nature. Such joining may be achieved with the two components (electrical or mechanical) and any additional intermediate members being integrally formed as a single unitary body with one another or with the two components. Such joining may be permanent in nature, or may be removable or releasable in nature, unless otherwise stated.

As used herein, the term “about” means that amounts, sizes, formulations, parameters, and other quantities and characteristics are not and need not be exact, but may be approximate and/or larger or smaller, as desired, reflecting tolerances, conversion factors, rounding off, measurement error and the like, and other factors known to those of skill in the art. When the term “about” is used in describing a value or an end-point of a range, the disclosure should be understood to include the specific value or end-point referred to. Whether or not a numerical value or end-point of a range in the specification recites “about,” the numerical value or end-point of a range is intended to include two embodiments: one modified by “about,” and one not modified by “about.” It will be further understood that the end-points of each of the ranges are significant both in relation to the other end-point, and independently of the other end-point.

For purposes of this disclosure, the terms “bulk,” “bulk composition” and/or “overall compositions” are intended to include the overall composition of the entire article, which may be differentiated from a “local composition” or “localized composition” which refers to a composition at a particular location, over a particular area, or over a particular volume on or within the article. The local composition may differ from the bulk composition owing, for example, to the formation of crystalline and/or ceramic phases.

As also used herein, the terms “article,” “glass-article,” “ceramic-article,” “glass-ceramics,” “glass elements,” “glass-ceramic article” and “glass-ceramic articles” may be used interchangeably, and in their broadest sense, to include any object made wholly or partly of glass and/or glass-ceramic material having a crystalline phase.

As used herein, a “glass” or “glass state” refers to an inorganic amorphous phase material within the articles of the disclosure that is a product of melt fusion that has cooled to a rigid condition without crystallizing. As used herein, a “glass-ceramic” or “glass-ceramic state” refers to an inorganic material within the articles of the disclosure which includes both the glass state and a “crystalline phase” and/or “crystalline precipitates” as described herein.

As used herein, “transmission”, “transmittance”, “optical transmittance” and “total transmittance” are used interchangeably in the disclosure and refer to external transmission or transmittance, which takes absorption, scattering, and reflection into consideration. Fresnel reflection is not subtracted out of the transmission and transmittance values reported herein. In addition, any total transmittance values referenced over a particular wavelength range are given as an average of the total transmittance values measured over the specified wavelength range. Transmittance is given by T=I/I₀ and is typically expressed as a percentage out of one-hundred.

The present disclosure generally relates to articles that are marked with identifying information or data and methods of effecting such markings. For example, the identifying information or data that is marked upon the article can include, but is not limited to, alphanumeric characters, patterns, barcodes, matrix barcodes (e.g., QR code), and the like. For brevity, regardless of the type of marking that is applied to the article, the present disclosure may simply refer to the alteration of the article as marks, marking, having marked the article, or the like. One of skill in the art will recognize that the markings applied to the article may take many forms without departing from the concepts disclosed herein. The markings can be employed to, for example, label the article with anti-counterfeiting markings, label the article with lot and/or batch number information, label the article with order information, and so on. In some examples, the mark may be referred to as an optical indicia.

In various examples of the present disclosure, an article that is marked can be a glass-ceramic article. The article that is marked may be a tungsten, molybdenum, titanium, iron, and/or magnesium containing glass ceramic, such as those disclosed in U.S. Pat. No. 10,246,371 entitled ARTICLES INCLUDING GLASS AND/OR GLASS-CERAMICS AND METHODS OF MAKING THE SAME; U.S. Pat. No. 10,370,291 entitled ARTICLES INCLUDING GLASS AND/OR GLASS-CERAMICS AND METHODS OF MAKING THE SAME; U.S. Pat. No. 10,450,220 entitled GLASS-CERAMICS AND GLASSES; U.S. Patent Application Publication No. 2019/0177206 (Ser. No. 16/190,712) entitled POLYCHROMATIC ARTICLES AND METHODS OF MAKING THE SAME; and PCT Application Publication No. 2019/051408A2, each of which is incorporated herein by reference in its entirety. In general, the compositions of the articles that have been marked by the process described herein may be referred to as sub-oxides. Tungsten bronzes are examples of sub-oxides. Crystalline structures that are present in the glass-ceramic articles of the present disclosure are capable of undergoing changes in oxidation state and changes in dopant concentration as a result of one or more heating processes applied during manufacture to effect various colors and/or color profiles for the glass-ceramic article. Similarly, the oxidation state and/or the dopant concentration of the crystalline structures of the present disclosure may be altered by the marking processes disclosed herein. In various examples, changes in the crystal structure, changes in stoichiometry, and/or changes in oxidation state induced by the beam from the laser may be accompanied by re-solubilization of the crystals such that the crystals are dissolved into the glass matrix. The traits of the crystalline structure of the glass-ceramic article have allowed the glass-ceramic articles of the present disclosure to bleach or be otherwise marked at relatively low temperatures.

Compositions of the glass-ceramic articles that were marked in the present disclosure can be used to produce glass-ceramic articles of various colors. In examples, the glass-ceramic articles may be a single color throughout, with the ability to vary the color of the glass-ceramic article during manufacture as a result of one or more heating processes. Alternatively, a color of the glass-ceramic articles may be varied throughout or the glass-ceramic article may be provided with a plurality of colors within a single article (e.g., polychromatic). For example, a single composition of the glass-ceramic article may be utilized to create a spectrum of glass-ceramic articles that each have a different color, different colors, or different color profiles. Such variation can be imparted to the glass-ceramic articles by way of heat treatment. Accordingly, the composition of the glass-ceramic article can be designed for a particular forming process (e.g., fusion forming, pressing, casting, etc.) and the glass-ceramic article can be subsequently processed with heat treatment(s) to adjust or tune a color and/or a saturation level of the glass-ceramic article to a desired color and/or saturation level. Regardless of the approach or method utilized in the formation of the glass-ceramic article, the glass-ceramic article may be marked by the techniques disclosed herein. The glass transition temperature, T_{g}, of the glass-ceramic articles marked by the process of the present disclosure differ from one another. However, the glass transition temperatures of each of the various compositions are in the range of about 400° C. to about 600° C.

“Glass transition temperature” is defined herein as the temperature at which a glass, or glass portion of a glass ceramic, has a viscosity of 10¹² Poise. “Annealing point” or “annealing temperature” is defined herein as the temperature at which a glass, or glass portion of a glass ceramic, has a viscosity of 10¹³ Poise. “Softening point” or “softening temperature” is defined herein as the temperature at which a glass, or glass portion of a glass ceramic, has a viscosity of 10⁷⁶ Poise. When cooling of the article is uniform, the glass transition temperature or annealing temperature may be approximately the same throughout the article. However, in the event that cooling in one portion of the article differed from the cooling in another portion of the article, then the glass transition temperature or the annealing temperature may be different in the portions with differing cooling rates or cooling histories. Local fluctuations in glass composition may also lead to slight variations in glass transition temperature or annealing temperature.

The desired color and/or saturation level of the glass-ceramic article can have an impact on a final contrast ratio of the marking that is applied to the glass-ceramic article. The methods of applying a marking to the glass-ceramic article disclosed herein are capable of bleaching the glass-ceramic article such that the region that is marked by the bleaching is transparent or substantially transparent in a given wavelength range (e.g., one or more wavelengths of the visible spectrum from about 380 nm to 740 nm). Accordingly, glass-ceramic articles that are produced with a greater saturation level may exhibit a greater resulting contrast ratio than glass-ceramic articles that are produced with a lower saturation level. While a selective application of one or more heating processes can be utilized to adjust the color and/or saturation level of the glass-ceramic article during manufacture, the local heating process disclosed herein (e.g., laser bleaching) that is used for marking the article may reverse the one or more heating processes to remove the color and/or decrease the saturation level in the regions that are marked. Accordingly, the marking applied to the article may bleach or otherwise alter a color or other property of the article in a region that has been marked. Examples of physical and chemical properties that are altered by interaction with the beam from the laser can include, but are not limited to, oxidation state, coordination number, structural phase, mechanical properties (e.g., local density and/or local stress), crystallinity, percent crystallinity, and/or thermal properties (e.g., T_{g}, fictive temperature, and/or specific heat).

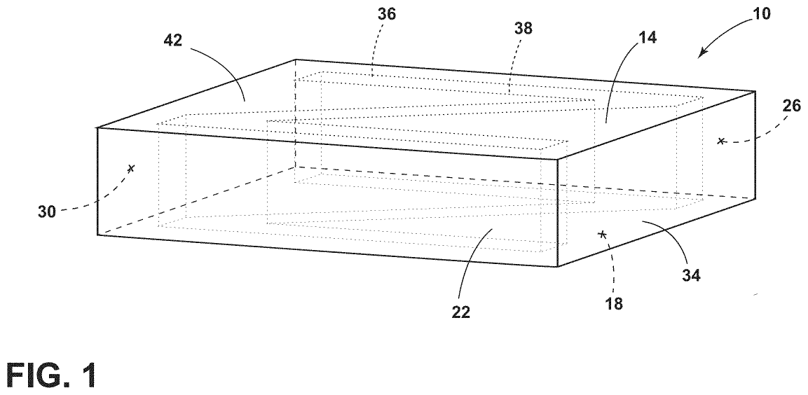

With reference to FIG. 1, an article 10 is depicted with a thickness, T, a width, W, and a length, L. The thickness, T, extends between a top surface 14 and a bottom surface 18 of the article 10. The width, W, extends between a front surface 22 and a rear surface 26 of the article 10. The length, L, extends between side surfaces 30, 34 of the article 10. A marking 36 is shown in phantom lines in exemplary form and is shown as a letter “N.” The marking 36 may extend through an entirety of the thickness, T, which extends between the top surface 14 and the bottom surface 18 of the article 10. The marking 36 may have a resolution that is the same or substantially the same through the entirety of the extent to which the marking 36 extends through the thickness, T. That is, a resolution of the marking 36 may be the same or substantially same at a portion of the marking 36 that is proximate to the top surface 14, at a portion of the marking 36 that is proximate to the bottom surface 18, and at a portion of the marking 36 that is intermediately positioned between the top surface 14 and the bottom surface 18. A first portion 38 of the article 10 is a portion of the article 10 that has been marked as a result of the interaction between the article 10 and the beam from the laser. A second portion 42 of the article 10 is a region of the article that has not been exposed to the beam from the laser. One of skill in the art will recognize that, while the article 10 is depicted in FIG. 1 as a rectangular substrate, the present disclosure is not so limited. Rather, the article 10 may be contoured such that one or more of the top surface 14, the bottom surface 18, the front surface 22, the rear surface 26, the side surface 30, and the side surface 34 are provided with inflection point(s), undulations, bevels, curvature, and/or other perturbations such that a given one of the surfaces may not lie entirely along a single plane.

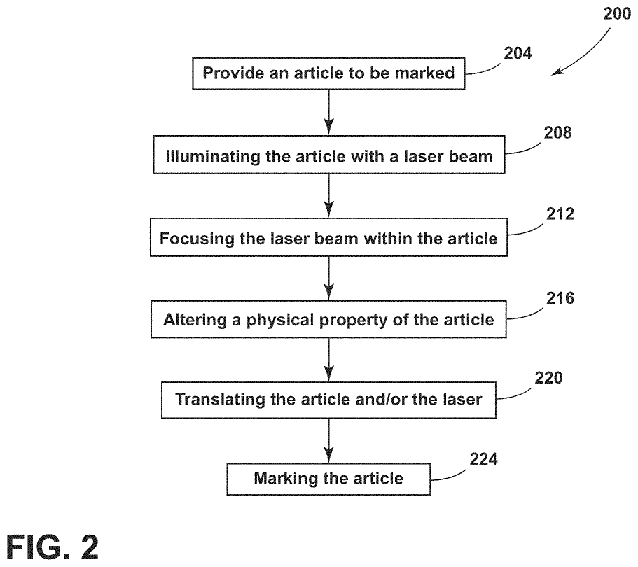

With reference to FIG. 2, a method 200 of marking a glass-ceramic article can include step 204 of providing a glass-ceramic article to be marked, the glass-ceramic article having the thickness, T. The method 200 of marking a glass-ceramic article further includes step 208 of illuminating the glass-ceramic article with a beam from a laser. The method 200 of marking a glass-ceramic article includes step 212 of focusing the beam from the laser within the thickness, T, of the glass-ceramic article. It is contemplated that the glass-ceramic article may be of standardized dimensions such that the beam from the laser may be focused in a calibration step prior to initiation of method 200 such that the step 208 of illuminating the glass-ceramic article with a beam from a laser and the step 212 of focusing the beam from the laser within the thickness, T, of the glass-ceramic article can be executed in a simultaneous or substantially simultaneous manner. In some examples, the step 208 of illuminating the glass-ceramic article with a beam from a laser and the step 212 of focusing the beam from the laser within the thickness, T, of the glass-ceramic article can be executed in a sequential manner. The method 200 of marking a glass-ceramic article includes step 216 of altering at least one of a physical property and a chemical property of the glass-ceramic article with the beam from the laser. The method 200 of marking a glass-ceramic article further includes step 220 of translating at least one of the glass-ceramic article and the laser. The method 200 of marking a glass-ceramic article may terminate with step 224 of marking the glass-ceramic article as a result of the alteration of the at least one of a physical property and a chemical property of the glass-ceramic article and the translation of at least one of the glass-ceramic article and the laser.

Exposing a substrate to electromagnetic radiation (e.g., by illuminating the substrate) often causes the substrate to increase in temperature, at least locally, when compared to the same substrate within the same environment and absent the exposure to electromagnetic radiation. For example, a substrate that is in an environment with a normal room temperature (e.g., often in the range of 18° C.-25° C.) and exposed to a source of electromagnetic radiation (e.g., a light source) may tend to have an elevated temperature when compared to the same substrate, within the same normal room temperature environment, but without the exposure to the source of electromagnetic radiation. The proximity of the substrate to the source of electromagnetic radiation, as well as the intensity of the electromagnetic radiation from the source of electromagnetic radiation can impact the degree to which the substrate is heated. Therefore, the step 208 of illuminating the glass-ceramic article with a beam from a laser and the step 212 of focusing the beam from the laser within the thickness, T, of the glass-ceramic article can result in local heating of the glass-ceramic article. The local heating of the glass-ceramic article as a result of the interaction between the beam from the laser and the glass-ceramic article can be substantial. For example, the local heating of the glass-ceramic article can result in the regions of the glass-ceramic article that have interacted with the beam from the laser being heated to greater than 200° C., greater than 300° C., greater than 400° C., greater than 500° C., greater than 600° C., greater than 700° C., greater than 800° C., greater than 900° C., or greater than 1000° C. during exposure to the beam from the laser.

Due to the substantial local heating of the glass-ceramic article in regions that have interacted with the beam from the laser, deformation and/or cracking can occur to the glass-ceramic article and can result in the glass-ceramic article being unusable or unsatisfactory for further use. Even if the glass-ceramic article does not deform or crack due to the interaction with the beam from the laser, the glass-ceramic article can acquire a build-up of residual stress that may be undesirable. In an effort to mitigate a build-up of residual stress in the glass-ceramic article that results from local heating of the glass-ceramic article due to the interaction between the beam from the laser and the glass-ceramic article, it is possible to pre-heat the glass-ceramic article prior to exposing the glass-ceramic article to the beam from the laser or to heat the glass-ceramic article during exposure of the glass-ceramic article to the beam from the laser such that a global temperature of the glass-ceramic article is elevated above ambient or normal room temperature. However, heating the glass-ceramic article to a global temperature that is elevated above ambient or normal room temperature represents additional processing time and additional processing costs. It is contemplated that, in various instances, the heating of the glass-ceramic article to a global temperature that is elevated above ambient or normal room temperature can result in a decrease in resolution (e.g., smearing) of the markings.

The methods of marking a glass-ceramic article of the present disclosure can be performed without employing a step of actively heating the entire glass-ceramic article prior to, or during, marking of the glass-ceramic article. Rather, a global temperature of the glass-ceramic article can be in the range of greater than about 0° C. to less than about 100° C. throughout the method of marking a glass-ceramic article. Said another way, the methods of marking a glass-ceramic article disclosed herein can be accomplished, while preventing or mitigating the build-up of residual stress, without employing a step of heating of the glass-ceramic article other than the heating that results from the interaction between the glass-ceramic article and the beam of the laser. Incidental or ambient heating contributed to the glass-ceramic article by ambient conditions, such as normal room temperature (e.g., often in the range of 18° C.-25° C.), is not intended to constitute an active heating step in the present disclosure. Accordingly, the methods of marking a glass-ceramic article disclosed herein may be performed entirely at ambient or room temperature.

The term “global temperature,” as used herein, is intended to refer to a bulk or average temperature of the glass-ceramic article as measured at a location on the glass-ceramic article that is remote from a region of the glass-ceramic article that is being actively marked with the beam from the laser. That is, the term global temperature is intended to refer to a temperature of the glass-ceramic article as measured at a location that is removed from an immediate vicinity of the region of the glass-ceramic article that is being actively marked. For example, the location that is removed from the immediate vicinity of the region of the glass-ceramic article that is being actively marked may be 5 mm or greater, 10 mm or greater, 15 mm or greater, 20 mm or greater, 25 mm or greater, or 30 mm or greater away from the region that is being actively marked.

The global temperature is established by a thermal source or thermal environment independent of the beam of the laser used to mark the glass-ceramic article. Examples of the thermal source or thermal environment include a furnace, an incandescent lamp, resistance heater, laser other than the marking laser, and ambient surrounding the glass-ceramic article. Locations having the global temperature correspond to regions whose temperature is unaffected by thermal effects associated with the marking laser. By “unaffected” is meant that thermal effects from the marking laser contribute less than 1° C. to the temperature at the location.

Global temperature accordingly refers to the temperature of the glass-ceramic article at positions unaffected by thermal effects from the laser beam used to mark the glass-ceramic article. The distance from the point of interaction of the marking laser beam with the glass-ceramic article at which the glass-ceramic article is at the global temperature depends on process parameters such as laser power, laser wavelength, time of exposure, etc. Under typical process conditions, locations of the glass-ceramic article having the global temperature are at a distance of 5 mm or greater from the center of the overlap of the beam cross-section of the beam of the marking laser with the incident surface of the glass-ceramic article.

The global temperature is also the temperature of the glass-ceramic article immediately preceding exposure of the glass-ceramic article to the beam of the laser used to mark the glass-ceramic article. Upon exposure of the glass-ceramic article to the marking beam, the region of the glass-ceramic article thermally influenced (“affected region”) by the beam is heated to a temperature above the global temperature and the region of the glass-ceramic article not thermally influenced (“unaffected region”) by the beam of the marking laser remains at the global temperature.

In order to alleviate stress, the marking method of the prior art includes pre-heating before exposure to a marking laser to mitigate stress and prevent fracture. Pre-heating leads to a high global temperature of the glass-ceramic article. In order to mitigate stress in the method of the prior art, a global temperature greater than 200° C. is required. The global temperature of the glass-ceramic article that is being actively marked using the methods described herein may be about 0° C., about 10° C., about 20° C., about 30° C., about 40° C., about 50° C., about 60° C., about 70° C., about 80° C., about 90° C., about 100° C., about 110° C., about 120° C., and/or combinations or ranges thereof. The methods described herein allow for marking of glass-ceramic articles with a laser to produce a marked glass-ceramic article without fracturing while maintaining the glass-ceramic article at a low global temperature during the marking process. The present methods therefore enable simpler, faster, and more convenient methods of marking glass-ceramic articles than has heretofore been possible.

The wavelength of the laser that is utilized to mark the glass-ceramic article in the present disclosure at least partially enables the marking of the glass-ceramic article to be carried out at ambient or normal room temperature. Specifically, the wavelength of the laser that was utilized in the present disclosure was chosen or tuned to coincide with a region of the transmission spectrum of the glass-ceramic article that has a relatively high transmittance. By so doing, the beam from the laser can fully penetrate the thickness, T, of the glass-ceramic article and uniformly interact with the glass-ceramic article. Accordingly, the marking of the glass-ceramic article can be effected more rapidly and with greater uniformity. Additionally, such a marking of the glass-ceramic article prevents build-up of stress on one side of the glass-ceramic article (e.g., a near-side of the glass-ceramic article relative to the laser), which may be referred to as asymmetrical stress. In contrast, when such care is not taken in selecting or tuning the wavelength of the laser relative to the transmittance spectrum of the glass-ceramic article, then the article being marked may experience further elevated temperatures as a result of interaction with the beam from the laser, markings are shallow, resolution is decreased, and/or there is a build-up of residual stress (e.g., asymmetrical stress). For example, many glass or glass-ceramic articles have a relatively low transmittance (high absorbance) at 10 μm. Carbon dioxide (CO₂) lasers, which emit light at a wavelength of 10.6 μm, are often used to mark glass or glass-ceramic articles. However, the beams from the CO₂ lasers are readily absorbed by these glass or glass-ceramic articles with relatively low transmittance at 10 μm, which results in low penetration into the article, thereby providing shallow markings. Additionally, the relatively low transmittance (high absorbance) of the article at the wavelength of the laser beam leads to significant heating of the article, which leads to a build-up of stress in the article as the heat diffuses into the article as a result of the marking process. Further, the stress that is built up in the article is an asymmetrical stress with the residual stress being greater on the side of the article that is nearest to the laser. This asymmetrical stress varies as a function of depth (i.e., thickness), width, and/or length within the article since the penetration of the laser beam is low and the heat dissipation or diffusion may not be uniform.

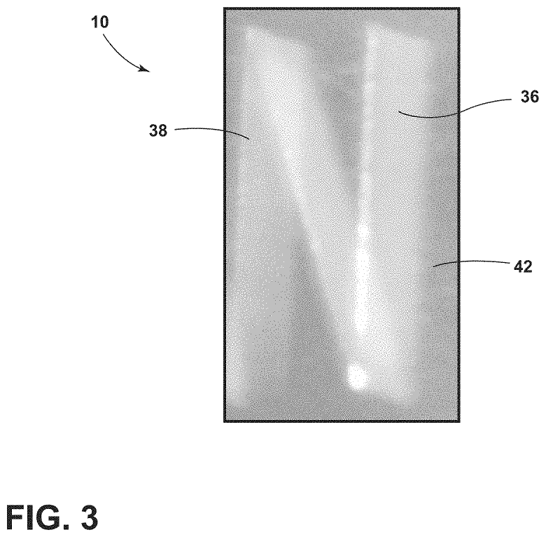

With reference to FIG. 3, an image of the representative marking 36 depicted in FIG. 1 is shown marked into the glass-ceramic article 10. In the image, the marking 36, which is the letter “N,” is approximately 3 mm tall from the base of the letter to the top of the letter and the article 10 has a thickness, T, of approximately 1.9 mm. The image was taken at a slight angle to illustrate the profile of the marking 36 extending through the entire thickness, T, of the article 10. The fine resolution of the marking 36 can also be appreciated from the image depicted in FIG. 3. The marking 36 of the glass-ceramic article 10 may be referred to as bleaching, laser bleaching, optical bleaching, or the like, which will be discussed further herein. The bleaching that is utilized to mark the glass-ceramic article 10 creates a contrast between marked (e.g., bleached) and unmarked (e.g., unbleached) regions of the glass-ceramic article 10, which may be referred to as a contrast ratio. The article 10 may exhibit a “Contrast Ratio” between a first portion 38 and second portion 42. The first portion 38 of the article 10 is a portion of the article 10 that has been marked as a result of the interaction between the article 10 and the beam from the laser. The second portion 42 of the article 10 is a region of the article that has not been exposed to the beam from the laser. The Contrast Ratio is defined as the average internal optical transmittance of the first portion 38 over a given wavelength range and a given distance in the thickness direction divided by the average internal optical transmittance of the second portion 42 over the same wavelength range and same distance in the thickness direction. Average internal optical transmittance, as used herein, refers to the total transmittance minus the Fresnel reflection from both surfaces of the glass-ceramic article 10 in the thickness direction (e.g., the top surface 14 and the bottom surface 18). Reference to the average internal optical transmittance over a given wavelength range or band refers to the average internal optical transmittance over that given wavelength range or band. Accordingly, discrete wavelengths within that given wavelength range or band may have an internal optical transmittance that is greater than or less than the average internal optical transmittance for the given wavelength range or band. Over a wavelength range of from about 400 nm to about 750 nm (e.g., visible light), the Contrast Ratio between the first portion 38 and the second portion 42 may be greater than 10, or greater than 100, or greater than 1,000, or greater than 10,000, or in the range of about 10 to about 100,000, or in the range of about 100 to about 10,000. For example, the Contrast Ratio between the first portion 38 and the second portion 42 may be about 100, about 1,000, about 10,000, about 100,000, or any intermediate value therebetween. The Contrast Ratio over the wavelength range of from about 400 nm to about 750 nm may be the Contrast Ratio at each of the wavelengths within the given wavelength range.

The marking of the article 10 may be referred to as bleaching or optical bleaching. According to one or more examples, the term “bleaching” and the phrase “optical bleaching” refer to the direction of thermal and/or photon energy to discrete regions or treating discrete regions of a glass or glass-ceramic substrate to increase the average internal optical transmittance in the discrete regions by partial or complete decomposition of crystalline phases in the discrete regions compared to portions of the substrate that have not been treated. Thus, the treated discrete regions that have been “bleached” or optically bleached exhibit an increased average internal optical transmittance compared to the portions of the substrate that have not been treated. In some embodiments, the treated discrete regions have an absorbance in a specific wavelength range (e.g., an infrared wavelength range, a visible wavelength range, and/or an ultraviolet wavelength range) that is reduced compared to portions of the substrate that have not been bleached. In some embodiments, for example, if a laser operating in the mid-infrared (mid-IR) wavelength range is used to bleach a discrete region of the substrate, decomposition of the crystalline phase that absorbs radiation in the mid-IR wavelength range occurs in the bleached discrete region, and absorption in the mid-IR is reduced compared to portions of the substrate that have not been bleached. In some embodiments, exposure to a mid-IR laser caused the absorbance of both the mid-IR and visible wavelengths to be reduced.

### Bleaching Techniques

According to one or more embodiments, glass-ceramic articles are processed in a way to optically bleach at least one discrete region in the article. Laser bleaching of glass-ceramics can occur due to a number of mechanisms or processes.

In absorbing glass-ceramic materials, the oxidation state of an ion (e.g. metal ion or ion complex such as tungstate or molybdate) may be altered by the laser bleaching. The ion may directly absorb the laser energy and change oxidation state, or may undergo a change in oxidation due to absorption by another constituent of the glass-ceramic and interaction (e.g. thermally or via electron transfer) with the absorbing constituent. For example, laser bleaching may initiate a redox reaction where an absorbing ion (e.g., a metal ion) is either oxidized or reduced from an absorbing or colored ion to a colorless or less intensely colored ion within a given wavelength spectrum (e.g., the visible spectrum). In various examples, the beam from the laser may be absorbed by OH groups within the glass-ceramic article, which in turn leads to a thermal event that causes or initiates a redox reaction between tungsten and/or other multivalent species in the glass-ceramic article that may donate and/or accept electrons from other components present in the glass-ceramic article (e.g., SnO₂). It is noted that some crystals of the type MₓWO₃, which will be discussed further herein, may absorb at the wavelength of the laser beam. In such instances, the MₓWO₃ crystals may absorb energy from the laser beam, heat as a result of the energy absorption, and cause decomposition of the crystal, thereby resulting in alkali de-intercalation from the crystal and the departure of the WO₃ anion. In some examples, the glass-ceramic article may experience an electron trapping effect as a result of the interaction of the laser beam with the glass-ceramic article in which electron capture by the absorbing ion or electron transfer from the absorbing ion leads to a change in oxidation state that increases optical transmittance within the given wavelength range in the region exposed to the beam of the laser.

In absorbing glass-ceramic materials that include at least one cation in a crystalline phase, bleaching may occur through a process of cation de-intercalation. In the cation de-intercalation process, the cation may be liberated from the crystals of the glass-ceramic article, thereby leaving behind an oxidized metal oxide (e.g., tungsten oxide) in regions of the glass-ceramic article that have been marked. In some embodiments, the de-intercalated cation may also undergo a change in oxidation state.

In absorbing glass-ceramic materials, upon exposure to the beam from the laser, the crystals within the glass-ceramic article that are within the path of the laser beam may be obliterated (vitrified) such that constituents of the crystal are returned to the glass, thereby resulting in dissolution of the crystal, which may be referred to as crystal amorphization or vitrification.

Absorbing glass-ceramic materials may be marked by exposing the glass-ceramic material to thermal energy. For example, laser bleaching can provide the thermal energy for marking a glass-ceramic material. It is possible to accomplish laser-induced bleaching by locally heating the glass to a temperature that is above a softening point of the glass (e.g., about 1000° C. for some embodiments). Heating the glass to a temperature above the softening point of the glass causes the glass to become transparent. Such intense heating may obliterate or remelt the crystals within the path of the laser beam and thereby return the constituents of the crystals to the glass.

In absorbing glass-ceramic materials, bleaching may also occur when glass-ceramic is converted into glass by rapid heating and cooling, including when the temperature of the region exposed to the beam of the laser is less than the temperature at the softening point. The rapid heating and cooling can be accomplished by exposing the glass-ceramic to a beam from a laser for a time frame that is sufficiently long to convert the glass-ceramic into glass, but sufficiently short to maintain a local temperature at the point of heating to a temperature below the softening temperature. For example, localized thermal heating to a localized temperature by one or more laser light sources can be used to dissolve or re-solubilize (e.g., through remelting) various small crystalline phases (e.g., crystallites, micrometer-sized crystals (10 micrometers or less in cross-sectional dimension) or nanometer-sized crystals (100 nanometers or less in cross sectional dimension)) in discrete localized regions of glass or glass-ceramic substrates exposed to the beam of the laser. While the disclosure is not to be limited by a scientific principle or theory, in one or more embodiments, localized heating of discrete regions of substrates to a localized temperature in excess of the global temperature results in a reversible redox reaction within the glass or glass-ceramic material that erases (e.g., dissociates, decomposes, solubilizes, or otherwise eliminates) a chromophore(s) in the form of small crystals that gives rise to visible absorbance. When the chromophores are erased, absorbance is reduced in the substrate, and average internal optical transmittance is increased. In some embodiments, the rate of heating or cooling can be varied by varying the power or degree of focusing of a CW (continuous wave) laser, or by varying the time of exposure of the glass-ceramic article to the laser beam.

In the experiments discussed herein, exposure of the glass-ceramic article to the beam from the laser did not produce any visible glow or emission (e.g., blackbody radiation) at the focal spot of the laser beam, which is indicative of a localized temperature having been below 600° C.-700° C. and thus below the softening point of the glass-ceramic article. Accordingly, the laser bleaching of the glass-ceramic article that is utilized to effect the marking of the glass-ceramic article, as disclosed herein, may occur due to a change of oxidation state of the absorbing ions and/or conversion of the glass-ceramic into glass by rapid heating and/or cooling (e.g., heating and/or cooling at a rate greater than 100° C. per second). However, the process of marking disclosed herein may not be an entirely thermal process. Accordingly, the marking process disclosed herein may mark the glass-ceramic article by a redox reaction, crystal dissolution, cation de-intercalation, and/or thermal processes. The marking process disclosed herein may utilize phonon absorption (e.g. by OH groups) instead of electronic absorption as typically occurs when ultraviolet (UV), visible, or near infrared (near-IR) lasers are employed.

Bleaching can be achieved using any suitable apparatus or system to increase the average internal optical transmittance in the discrete region. In one or more embodiments, bleaching is achieved by thermally treating the discrete region. Such thermal treatment may be performed using those energy sources known in the art, such as, but not limited to, furnaces, flames such as gas flames, resistance furnaces, lasers, microwaves, or the like. Laser bleaching has been determined to provide substrates with discrete regions having increased the average internal optical transmittance after bleaching and may provide greater resolution of bleached markings.

The laser bleaching disclosed herein is capable of achieving high-contrast bleaching with fine resolution. Achieving high-contrast bleaching with fine resolution can be accomplished when the glass-ceramic article has moderate to low absorption at the wavelength of the laser and the beam from the laser is tightly focused. In accomplishing the fine resolution, it may be beneficial for the moderate to low absorption at the wavelength of the laser and the beam from the laser being tightly focused to be accompanied by the glass-ceramic article having rapid heating and cooling rates.

The laser bleaching disclosed herein is also capable of achieving high-aspect ratio bleaching. Aspect ratio is defined as a ratio of width to height of an image and is similarly applicable to the discussion of markings that are bleached into the glass-ceramic article. The markings that are laser bleached into the glass-ceramic article, as disclosed herein, can extend through an entirety of the thickness, T, of the glass-ceramic article. A resolution of the marking, as used herein, refers to a width of a single stroke or pixel of the marking, where width refers to a distance in a direction perpendicular to the thickness direction of the glass-ceramic article. A width, or resolution, of the marking can be 100 μm or less. That is, the width of a single “stroke” of laser bleaching (e.g., an upward stroke to establish a first leg of the letter “N”) can be 100 μm or less while the length or height of that single stroke may be greater than 100 μm. Said another way, the width or diameter of a single “pixel” of laser bleaching can be 100 μm or less and may extend through the entirety of the thickness of the glass-ceramic article. Height of an image refers to the dimension of the image in the thickness direction of the glass-ceramic article. Accomplishing the narrow width of the bleached marking, in combination with the through-thickness or substantially through-thickness bleaching disclosed herein, provides high aspect ratio bleaching of glass-ceramic articles. Additionally, as the width of the marking decreases, the residual stress that is introduced into the glass-ceramic article also decreases. Use of lasers with wavelengths of emission that are not aligned with a moderate to low absorption region of the transmittance spectrum of the glass-ceramic article (e.g., lasers with emission at shorter wavelengths) inhibits the ability of the marking process to effect fine resolution markings with high aspect ratios. Even if the lasers with wavelengths of emission that are not aligned with moderate to low absorption regions of the transmittance spectrum of the glass-ceramic article were focused to a tight spot (i.e., small diameter), due to intense absorption at the surface of the glass-ceramic article, the resulting local heating, low penetration in the thickness direction, and the diffusion of that heat within the glass-ceramic article, the marking imparted to the glass-ceramic article was blurred and had a low aspect ratio.

In general, it may be beneficial to select a wavelength of emission for the laser that corresponds to a region in the transmittance spectrum of the article that with a transmittance of at least 10%/mm, at least 20%/mm, at least 30%/mm, at least 40%/mm, at least 50%/mm, at least 60%/mm, at least 70%/mm, less than 80%/mm, less than 70%/mm, less than 60%/mm, less than 50%/mm, less than 40%/mm, less than 30%/mm, less than 20%/mm, and/or combinations or ranges thereof. It is contemplated that as the percent transmittance of the wavelength of the beam from the laser increases for a given article, the power utilized for effective marking may increase.

### EXAMPLES

The following examples represent certain non-limiting examples of the composition of the glass-ceramic articles and/or methods of marking the glass-ceramic articles of the present disclosure.

Preliminary bleaching experiments were conducted using a continuous wave (CW) laser operating at 7-9 W of power. The laser was tuned to between 2.5 μm and 2.6 μm.

Marking of the glass-ceramic articles was accomplished with the glass-ceramic article resting upon an XYZ translational stage. The XYZ translational stage was moved at a rate of 1 mm/s, which was limited by the weight and the inertia of the XYZ translational stage holding the glass-ceramic article. Increasing the rate of translation of the XYZ translational stage during marking of the glass-ceramic article resulted in distortion of the pattern or character being marked, particularly at points where a direction of travel was changed (e.g., corners). A substantial increase in the speed of translation, and ultimately marking, can be achieved when utilizing a galvanometer scanner, which allowed for translation speeds of up to 1-2 m/s. With such a scanner, the pattern or character can be bleached by multiple consecutive high-speed scans. It is contemplated that in the various examples of the present disclosure the laser and/or the glass-ceramic article may be translated along X-, Y-, and/or Z-directions.

Table 1, below, provides an exemplary composition of the glass-ceramic article 10 that was marked according to the marking process outlined herein, with the individual constituents represented in as-batched mole percent (mol %).

TABLE 1

| | As-Batched Concentration |
|---|---|
| Constituent | (mol %) |
| SiO₂ | 55.3310 |
| Al₂O₃ | 10.8520 |
| B₂O₃ | 12.6720 |
| Li₂O | 5.4300 |
| Na₂O | 6.6320 |
| K₂O | 0.0230 |
| SnO₂ | 0.1430 |
| WO₃ | 3.2510 |
| CaO | 0.1190 |
| Ag | 0.1170 |
| F— | 5.4300 |
| Total | 100 |

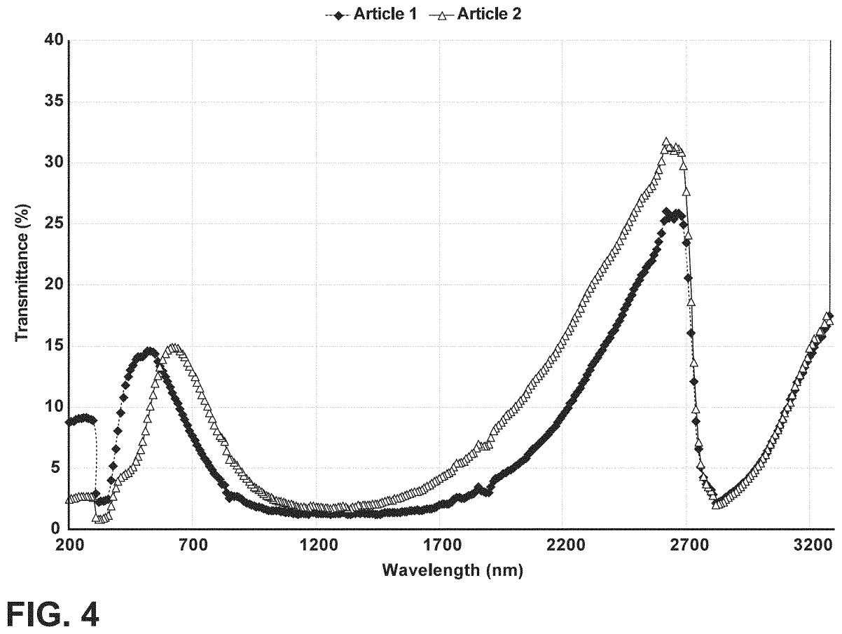

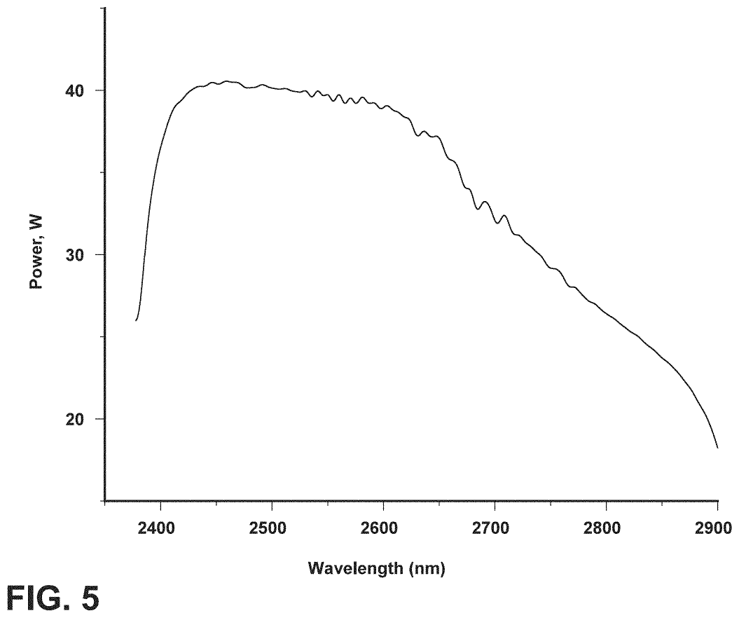

With reference to FIG. 4, total transmittance spectra of two exemplary glass-ceramic articles, Article 1 and Article 2, are shown. Articles 1 and 2 were made from the composition outlined in Table 1, above. Each of Article 1 and Article 2 had a thickness of 1.5 mm. The heat treatments that Articles 1 and 2 were exposed to during manufacture differed, which resulted in Articles 1 and 2 exhibiting different visible colors. Article 1 was blue and Article 2 was brown following their respective heat treatments. The different heat treatments that resulted in Articles 1 and 2 exhibiting differing visible colors is in reference to the articles prior to marking. Articles 1 and 2 were each treated in an ambient air electric oven. Article 1 was heat treated by increasing a temperature within the oven from room temperature to 510° C. at a rate of 10° C. per minute, the temperature within the oven was then held at 510° C. for one hour, the temperature within the oven was then decreased to 425° C. at a rate of 1° C. per minute, and, finally, the temperature within the oven was decreased to room temperature at a rate of 10° C. per minute. Article 2 was heat treated by increasing a temperature within the oven from room temperature to 525° C. at a rate of 10° C. per minute, the temperature within the oven was then held at 525° C. for thirty minutes, the temperature within the oven was then decreased to 450° C. at a rate of 1° C. per minute, and, finally, the temperature within the oven was decreased to room temperature at a rate of 10° C. per minute. Both Article 1 and Article 2 have transmittance maxima at approximately 2.6 μm, which is before a strong —OH fundamental absorption at approximately 2.7 μm. An absorption maximum in the regions that had not been marked with the beam from the laser occurred at 2860 nm while the absorption maximum in the regions that had been marked with the beam from the laser occurred at 2840 nm. A laser tuning curve of the continuous wave (CW) laser utilized in these experiments can be seen in FIG. 5. The laser used was tuned to a wavelength of between 2.5 μm and 2.6 μm such that, during bleaching, the beam from the laser interacted with the glass-ceramic article within the transmittance maxima at approximately 2.6 μm for both Article 1 and Article 2. By tuning the laser wavelength to be in the range of 2.5 μm to 2.6 μm, attenuation of the beam from the laser as a function of depth within the glass-ceramic article was low. (When normalized to a thickness of 1 mm, the transmittance of Article 1 is approximately 19% and the transmittance of Article 2 is approximately 47% at a wavelength of 2550 nm.) Additionally, the low attenuation with depth as a result of tuning the laser wavelength to correspond with the transmittance maxima of Article 1 and Article 2 enabled nearly simultaneous interaction with the beam from the laser through the entirety of the thickness, T, of the glass-ceramic articles. Forming marks in Article 1 and Article 2 by tuning the wavelength of the beam from the laser to 2.55 μm produced marks with high Contrast Ratios of 8 or greater in the wavelength band from 400 nm to 750 nm. As used herein, Contrast Ratios over a given wavelength band refer to the average internal optical transmittance over the given wavelength band. By tuning the laser such that the wavelength of the beam emitted from the laser was within a low absorption (high transmission) region of the transmittance spectra of the glass-ceramic articles, it was possible to simultaneously expose the glass-ceramic article to the irradiation from the laser through the entire thickness of the glass-ceramic article and accomplish bleaching extending from the top surface 14 to the bottom surface 18. Such a tuning of the laser to a low absorption (high transmission) region of the transmittance spectra may be referred to as “off-peak” tuning or “off-peak” excitation. In one specific example, a glass-ceramic article with a thickness of 1.5 mm was marked. The percent transmittance of the region that was not marked by the beam from the laser was 8% for the glass-ceramic article with a thickness of 1.5 mm. The percent transmittance of the region that was marked by the beam from the laser was 58% for the glass-ceramic article with a thickness of 1.5 mm.

In addition to enabling through-thickness bleaching, tuning the laser such that the wavelength of the beam emitted from the laser was within a low absorption region resulted in the glass-ceramic article experiencing a lesser amount of local heating from the laser beam. Additionally, the local heating that did occur as a result of the interaction between the beam from the laser and the glass-ceramic article was more symmetrical and uniform in the thickness direction, thereby generating less of a thermal gradient through the thickness of the glass-ceramic article and ultimately decreasing a stress build-up in the glass-ceramic article. In cases where a laser with a wavelength of emission that does not align with a moderate to low absorption region of the transmission spectrum of the glass-ceramic article is used, the increased absorption of the beam from the laser by the glass-ceramic article results in increased local heating, a thermal mismatch between a near side and a far side of the article, and a build-up of stress within the article that can lead to the article being unusable for further processing and/or sale. Achieving the through-thickness bleaching while also imparting a lesser amount of local heating to the glass-ceramic article required tuning the laser beam to a wavelength of high transmittance in the mid-infrared (mid-IR). While the compositions of the glass-ceramic articles tested have dictated that the wavelength of the laser beam be at a wavelength in the mid-IR, one of skill in the art will recognize that other compositions of glass-ceramic articles may be marked without departing from the concepts disclosed herein. Marking of the glass-ceramic articles using the concepts disclosed herein resulted in local heating of the glass-ceramic article that was much lower than expected. In previous processes that have been utilized to mark glass-ceramic articles, marking was accomplished using a laser beam with a wavelength tuned to a region of low transmittance (high absorption) in the spectrum of the glass-ceramic article and a bright light was often observed as emitting from the glass-ceramic article during the marking process in the region that was being actively marked. This bright light may be due to fluorescence, luminescence, and/or blackbody radiation of the glass-ceramic article being marked. A color of the bright light can be used to determine an approximate temperature of the glass-ceramic article during marking. In the previous processes, the color of the light or emission, as observed by the naked eye, that was given off by the interaction between the beam from the laser and the glass-ceramic article was bright yellow or white in color, which was indicative of local heating of the glass-ceramic article to a temperature of about 700° C. or more due to the strong absorption of the beam from the laser. Temperatures approaching about 700° C. may exhibit a dull or faint light or emission, however, the light or emission is minimal due to the interaction volume between the laser beam and the article being low and the exposure time being short. The marking processes disclosed herein either exhibited a light or glow that was red in color and was less intense than that observed previously. In some examples, the light or glow was not observed at all. Accordingly, the marking processes of the present disclosure exhibit characteristics that are indicative of temperatures of the glass-ceramic article less than about 700° C. in the region of local heating in the marking process described herein. Additionally, the glass-ceramic articles that were marked with the processes disclosed herein did not break or crack, which may be a result of low thermal stresses due to the low local temperature at the point of interaction of the beam of the laser with the glass-ceramic article. Further, the marking process disclosed herein did not require heating the entire glass-ceramic article (e.g., near T_{g}, at T_{g}, or above T_{g}) to an elevated temperature in an effort to prevent a build-up of residual stress.

Using the marking process described herein, the glass-ceramic article was able to be handled by a user without the use of protective equipment (e.g., with bare hands) nearly immediately (e.g., within 5 seconds or less) after marking was completed. It was noted that during experimentation, the temperature of the glass-ceramic article during the marking process at a location that was approximately 5 mm away from the region that was being actively bleached was at a temperature that was little more than room temperature (e.g., less than 30° C., less than 35° C., or less than 40° C.). Measuring the temperature of the article in a region that is in close proximity to the actively marked region may be accomplished, for example, by use of an optical pyrometer. Accordingly, it was observed that the temperature of the glass-ceramic article as a function of distance from the region being actively marked drops off rapidly. This rapid drop off of article temperature as a function of distance from the point of interaction of the beam of the laser with the glass-ceramic article can be attributed, at least in part, to the rapid heating and cooling rates of the glass-ceramic article and/or off-peak excitation wavelength. The rapid heating and cooling rates may be 100° C. or greater, 200° C. or greater, 300° C. or greater, 400° C. or greater, or 500° C. or greater. The rapid heating and cooling rates may be accomplished as a result of a low interaction volume between the laser beam and the article due to the tight focus of the beam and a short exposure time (e.g., less than 1 second, less than 2 seconds, less than 3 seconds). While the dimensions of the glass-ceramic article being marked may impact the global temperature of the glass-ceramic article, the global temperatures for the glass-ceramic articles marked with the marking process disclosed herein may be less than 120° C., less than 110° C., less than 100° C., or less than 90° C.

The marking applied to the glass-ceramic article exhibited a high aspect ratio. Several factors are taken into account when pursuing high aspect ratio bleaching of the character, pattern, or the like that is bleached or marked upon the glass-ceramic article. In general, appropriate focusing conditions are selected to achieve the high aspect ratio bleaching. When the beam from the laser is tightly focused, the width of the individual pixels or strokes of the marking performed by the interaction between the beam from the laser and the glass-ceramic article are narrow. The width of the individual pixels or strokes of the markings made upon the glass-ceramic article are one of the factors that lead to high aspect ratio bleaching. However, a tightly focused beam is accompanied by a higher numerical aperture (NA) of the beam and, correspondingly, higher beam focusing angle, which results in wider marked paths outside of the focal spot of the beam from the laser (e.g., due to divergence from the focal spot). In the experiments involving Article 1 and Article 2, a numerical aperture of 0.1 (NA=0.1) was chosen. The numerical aperture being equal to 0.1 produced a focal spot within the glass-ceramic article of about 12-13 μm and a beam spot diameter on each of the top surface 14 and the bottom surface 18 of about 80 μm with the thickness, T, of the glass-ceramic article being 1.9 mm. The width of the bleached pattern (see FIG. 3) was approximately 100 μm, which closely resembles the beam spot diameter on the surfaces of the glass-ceramic article. The aspect ratio in these specific examples was about 19. Resolution of the marking can be increased when smaller patterns are bleached. When bleaching smaller patterns, it was possible to obtain widths of 10-20 μm for individual pixels or strokes when marking the glass-ceramic article. The smaller patterns with widths of 10-20 μm were accomplished by focusing the beam to a spot that was less than 13 μm in diameter. For example, patterns with stroke or pixel widths of about 20 μm were accomplished by focusing the beam spot to a diameter of about 13 μm. The stroke or pixel width is a function of numerical aperture and the thickness of the glass-ceramic article. As the beam from the laser is focused to smaller diameters, the divergence of the beam increases as a function of distance from the focal spot, which results in wider marking on the surface of the glass-ceramic article. Adjusting a positioning of the focus of the beam from an optimal location by +/−0.25 mm from the optimum location did not result in a noticeable change in the Contrast Ratio or the width of the pattern or character that was bleached. It was observed that a power range of the laser was somewhat broad (approximately 7-9 W), which may have been due to absorption saturation.

Focusing the beam from the laser within the thickness, T, of the glass-ceramic article to a focal spot diameter (beam waist) of less than about 13 μm with a low numerical aperture of about 0.1 enabled a reduction in the width of the bleached channels to 20 μm or less. In various examples, the beam shape of the beam from the laser may be Gaussian. While some residual stress may have been introduced into the glass-ceramic article, the magnitude and spatial scale of the residual stress did not cause cracking in the glass-ceramic article.

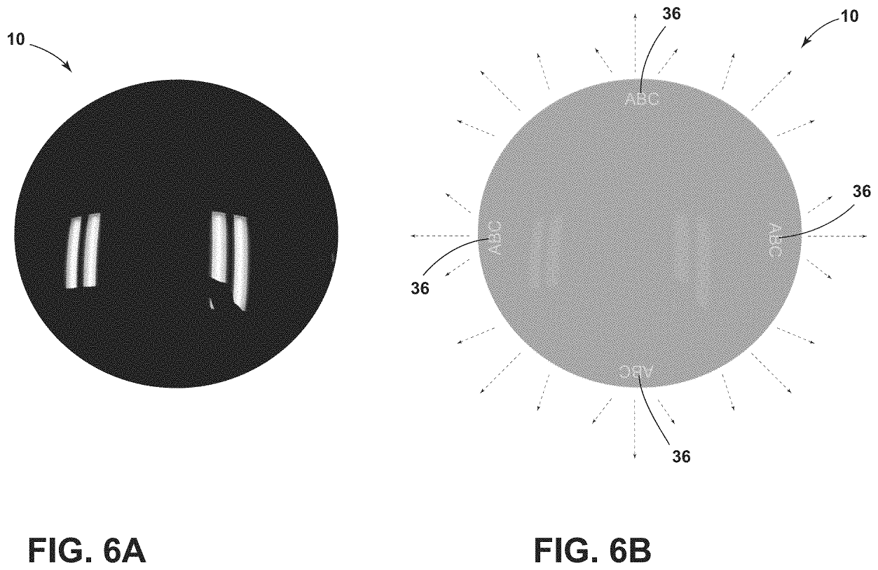

With reference to FIGS. 6A and 6B, one of the glass-ceramic articles 10 that was marked by the marking process disclosed herein is shown with reflected light (FIG. 6A) and transmitted light (FIG. 6B). The composition of the glass-ceramic article 10 depicted in FIGS. 6A and 6B was the same as that outlined in Table 1, above, and the transmittance spectrum was similar to that shown for Articles 1 and 2 in FIG. 4. The article 10 may not show the marking 36 when light is reflected off of the surface of the article 10. However, when light is transmitted through the article 10, the marking 36 may present itself.

The crystalline structures in the glass-ceramic article 10 are relatively small and are present in low abundance. The crystalline structures may be present at about 5% to about 10% by weight relative to non-crystalline components of the glass-ceramic article 10. Due to the relatively small size (e.g., 5-15 nm) and the low abundance of the crystalline structures, characterization of the crystalline structures can be difficult. For example, the crystalline structures appear x-ray amorphous such that x-ray diffraction measurements and characterization were unsuccessful in elucidating meaningful information about the crystalline structures. Accordingly, Raman spectroscopy was employed.

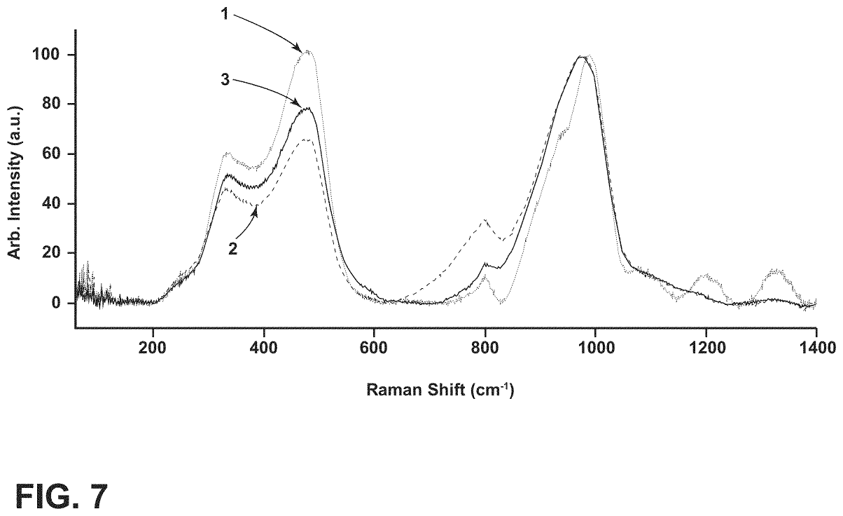

With reference to FIG. 7, Raman spectra of articles with the composition outlined in Table 1, above, are shown at various stages of the manufacturing and/or marking process. The Raman spectra depicted are of an article that was manufactured and not heat-treated (see dotted line labeled 1), a region of a heat-treated article that was not marked with a laser (see dashed line labeled 2), and a region of a heat-treated article that was marked with a laser (see solid line labeled 3). The article that was manufactured and not heat-treated (dotted line labeled 1) represents a “blank” substrate that was not subjected to the heat treatment(s) that would lead to the coloration of the article 10. The heat-treated article (dashed line labeled 2 and solid line labeled 3) underwent the same heat treatment program as that outlined above for Article 1, with the dashed line labeled 2 corresponding to a region that was not marked with the laser and the solid line labeled 3 corresponding to a region that was marked with the laser. Marking of the glass-ceramic article was conducted using a continuous wave (CW) laser operating at 7-9 W of power. The laser was tuned to between 2.5 μm and 2.6 μm. The numerical aperture was 0.1 and produced a focal spot within the glass-ceramic article of about 12-13 μm. A beam spot diameter on each of the top surface 14 and the bottom surface 18 was about 80 μm. The thickness, T, of the glass-ceramic article was 1.9 mm. The width of the bleached pattern was approximately 100 μm. Marking of the glass-ceramic article was accomplished with the glass-ceramic article resting upon an XYZ translational stage. The XYZ translational stage was moved at a rate of 1 mm/s, which was limited by the weight and the inertia of the XYZ translational stage holding the glass-ceramic article. The Raman spectra were collected using the experimental conditions outlined in Table 2, below.

TABLE 2

| Microscope | Horiba LabRAM HR Evolution |
|---|---|
| Magnification | 100X |
| Laser Power | 100 mW |
| Laser | 532 nm |
| Wavelength | |
| Exposure | 30 sec |
| Time | |
| Accumulations | 5 |

The non-heat-treated article (see dotted line labeled 1) was a transparent or translucent yellow color, the heat-treated article 10 in the region that was not marked (see dashed line labeled 2) was a blue color, and the heat-treated article 10 in the region that was marked was a yellow color (see solid line labeled 3). The yellow color of the heat-treated article 10 in the region that was marked was similar to the non-heat-treated article. The blue coloration achieved through the heat treatment(s), and exhibited in the heat-treated article 10 in the region that was not marked, arose from the formation of tungsten bronze crystals. Varying the heat treatment(s) time(s) and temperature enables the tuning of the identity of the dopant or intercalating ion and its concentration within the tungsten bronze crystals, resulting in the ability to provide different colors of the heat-treated article 10, which may then be marked. For example, the tungsten bronze crystals may be doped or intercalated with various 1+ cations. The tungsten bronze crystals give rise to a peak at about 780 cm⁻¹ in the Raman spectra. As can be seen in FIG. 7, the non-heat-treated article (see dotted line labeled 1) exhibits a relatively small peak at about 780 cm′. In contrast, the region of the heat-treated article 10 that was not marked (see dashed line labeled 2), and which was blue in color, exhibited a peak at about 780 cm⁻¹ that was more than double the intensity of the same peak for the non-heat-treated article. The region of the heat-treated article 10 that was marked (see solid line labeled 3), and which was a yellow color similar to that of the non-heat-treated article, exhibited a peak at about 780 cm⁻¹ with similar intensity to that of the same peak for the non-heat-treated article. The similar coloration and the similarities in the Raman spectra at about 780 cm⁻¹ between the non-heat-treated article and the region of the heat-treated article 10 that was marked indicate that the exposure of the article 10 to the beam from the laser reverses or “erases” the tungsten bronze crystal(s) in the marked region. While laser irradiation does not fully transform the tungsten back into WO₄²⁻ in the glass matrix or glass phase, the laser irradiation clearly can “break-up” the crystalline bronze phase or cause the crystalline bronze phase to become partially amorphized. Without being bound by theory, it is believed that this breaking-up or amorphization of the tungsten bronze crystals is caused by a de-intercalation of the tungsten bronze crystal and a simultaneous redox reaction causing the majority of the tungsten to oxidize back to the six-plus (6+) state.

Tungsten bronzes are non-stoichiometric compounds generally of formula MₓWO₃, where M is a cation dopant, such as some other metal, most commonly an alkali, and x is a variable less than 1. For clarity, though called a ‘bronze’, these compounds are not structurally or chemically related to metallic bronze, which is an alloy of copper and tin. Tungsten bronzes are a spectrum of solid phases where homogeneity varies as a function of x. Depending on dopant M and corresponding concentration x, material properties of a tungsten bronze may range from metallic to semi-conducting, and exhibit tunable optical absorption. The structure of these bronzes is a solid-state defect structure in which M′ cations intercalate into holes or channels of binary oxide hosts and disassociate into M⁺ cations and free electrons.

For clarity, MₓWO₃ is a naming convention for a complex system of non-stoichiometric or ‘sub-stoichiometric’ compounds, with varying crystal structures that can be hexagonal, tetragonal, cubic, or pyrochlore, where M can be one or a combination of certain elements on the periodic table, where x varies from 0<x<1, where the oxidation state of the bronze-forming species (in this case W) is a mixture of the species in its highest oxidation state (W⁶⁺) and a lower oxidation state (e.g., W⁵⁺), and where the number three (“3”) in WO₃ represents the number of oxygen anions that may be between 2 and 3. Accordingly, MₓWO₃ may alternatively be expressed as the chemical form MₓWO_{z}, where 0<x<1, and 2<z<3, or as MₓWO₃-z where 0<x<1 and 0<z<1. However, for brevity, MₓWO₃ is utilized for this family of non-stoichiometric crystals. Similarly, ‘bronze’ in general applies to a ternary metal oxide of formula M′ₓM″_{y}O_{z} where (i) M″ is a transition metal, (ii) M″_{y}O_{z} is its highest binary oxide, (iii) M′ is some other metal, (iv) x is a variable falling in the range 0<x<1. Examples of bronze-forming species include, but are not limited to, molybdenum and titania.

In various examples of the present disclosure, a glass-ceramic is provided that includes a silicate-containing glass, the silicate-containing glass includes a first portion and a second portion. A plurality of crystalline precipitates that include at least one of W and Mo may be present in the silicate-containing glass. The crystalline precipitates may be distributed within at least one of the first and second portions of the silicate-containing glass. The glass-ceramic article can exhibit a Contrast Ratio between the first and second portions that is at least 2 over a wavelength range of from 400 nm to 750 nm. In some examples, the glass-ceramic article exhibits a Contrast Ratio of between about 100 and about 100,000 over a wavelength range of from 400 nm to 750 nm. In various examples, the Contrast Ratio may be calculated by comparing the average internal optical transmittance in a region that is marked to the average internal optical transmittance in a region that has not been marked. Accordingly, an average internal optical transmittance in the marked region may be at least 2 times the average internal optical transmittance over at least a 50 nm wide wavelength window in the unbleached or unmarked region of the glass-ceramic article. In some examples, the average internal optical transmittance in the marked region may be between about 100 and about 100,000 times greater than the average internal optical transmittance of the unbleached or unmarked region over at least a 50 nm wide wavelength window.

In some examples of the present disclosure, a method of forming a glass-ceramic article is provided that includes: forming a glass substrate having a substantially homogenous bulk composition, wherein the glass substrate includes a first portion and a second portion; and variably crystallizing at least one of the first and second portions of the substrate to form a plurality of crystalline precipitates within the at least one of the first and second portions.

It will be understood that any described processes, or steps within described processes, may be combined with other disclosed processes or steps to form structures within the scope of the present disclosure. The exemplary structures and processes disclosed herein are for illustrative purposes and are not to be construed as limiting.

It is also to be understood that variations and modifications can be made on the aforementioned structures and methods without departing from the concepts of the present disclosure, and, further, it is to be understood that such concepts are intended to be covered by the following claims, unless these claims, by their language, expressly state otherwise. Further, the claims, as set forth below, are incorporated into and constitute part of this Detailed Description.

It will be apparent to those skilled in the art that various modifications and variations can be made without departing from the spirit or scope of the claims.

What is claimed is:

1. A method of marking a glass-ceramic article, the method comprising the steps of:
illuminating the glass-ceramic article with a beam from a laser, the glass-ceramic article having a thickness, T;
forming a mark in the glass-ceramic article while translating at least one of the glass-ceramic article or laser, the mark having a Contrast Ratio greater than 10, the step of forming a mark comprising focusing the beam from the laser within the thickness, T, of the glass-ceramic article, the focusing of the beam altering at least one property chosen from a chemical property and a physical property of the glass-ceramic article, the mark produced by the beam from the laser extending through at least 50% of the thickness, T, of the glass-ceramic article.

2. The method of marking a glass-ceramic article of claim 1, wherein the mark produced by the beam from the laser extends through at least 80% of the thickness, T, of the glass-ceramic article.

3. The method of marking a glass-ceramic article of claim 2, wherein the mark produced by the beam from the laser extends through an entirety of the thickness, T, of the glass-ceramic article.

4. The method of marking a glass-ceramic article of claim 1, wherein a global temperature of the glass-ceramic article is less than 100° C. throughout the method of marking a glass-ceramic article, and wherein the glass-ceramic article does not fracture as the mark is formed.

5. The method of marking a glass-ceramic article of claim 1, wherein an interaction between the beam from the laser and the glass-ceramic article provides the sole source of heating in the method of marking a glass-ceramic article.

6. The method of marking a glass-ceramic article of claim 1, wherein the glass-ceramic article comprises OH groups, and wherein the beam from the laser has a wavelength that is absorbed by the OH groups.

7. The method of marking a glass-ceramic article of claim 1, wherein the focusing the beam from the laser comprises heating a local region of the glass-ceramic article to a temperature above the global temperature.

8. The method of marking a glass-ceramic article of claim 7, wherein the temperature above the global temperature is above a glass transition temperature, T_{g}, of the glass-ceramic article.

9. The method of marking a glass-ceramic article of claim 7, wherein the temperature above the global temperature is below a softening point of the glass-ceramic article.

10. The method of marking a glass-ceramic article of claim 7, wherein the temperature above the global temperature is less than 1000° C.

11. The method of marking a glass-ceramic article of claim 7, wherein the temperature above the global temperature is less than 700° C.

12. The method of marking a glass-ceramic article of claim 1, wherein the at least one property chosen from a chemical property and a physical property is an oxidation state of an ion of the glass-ceramic article.

13. The method of marking a glass-ceramic article of claim 1, wherein the at least one property chosen from a chemical property and a physical property is a crystalline volume fraction of the glass-ceramic article.

14. The method of marking a glass-ceramic article of claim 1, wherein the mark has a Contrast Ratio greater than 1,000.

15. The method of marking a glass-ceramic article of claim 1, wherein the global temperature is less than 50° C.

16. The method of marking a glass-ceramic article of claim 1, wherein the beam of the laser comprises a wavelength and an average internal optical transmittance of the wavelength through the thickness, T, of the glass-ceramic article is greater than 20%/mm.

17. The method of marking a glass-ceramic article of claim 1, wherein the beam of the laser comprises a wavelength and an average internal optical transmittance of the wavelength through the thickness, T, of the glass-ceramic article is greater than 30%/mm.

18. The method of marking a glass-ceramic article of claim 1, wherein the beam of the laser comprises a wavelength and an average internal optical transmittance of the wavelength through the thickness, T, of the glass-ceramic article is greater than 40%/mm.

19. The method of marking a glass-ceramic article of claim 1, wherein the beam of the laser comprises a wavelength within the range of 2500 nm and 2800 nm.

20. The method of marking a glass-ceramic article of claim 1, wherein the mark has a width in the range of 10-20 μm.
